(19) United States
(12) Patent Application Publication
(10) Pub. No.: US 2008/0270269 A1
(43) Pub. Date: Oct. 30, 2008

(54) Method for stock record verification for small inventory populations

(76) Inventors: Gerald Lee Myers, Heyworth, IL (US); Zhiming Qu, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/790,726

(22) Filed: Apr. 27, 2007

(51) Int. Cl. G06Q 10/00

(52) U.S. Cl. 705/28

(57) ABSTRACT

A method for stock record verification for small inventory populations comprises establishing a first group that includes a plurality of part numbers having values above a predetermined threshold, and establishing a second group that includes a plurality of part numbers having values below the predetermined threshold. A plurality of part numbers is randomly selected from among the plurality of part numbers in the second group. The method also includes receiving physical count data associated with each of the part numbers in the first group and the randomly selected part numbers from the second group. An inventory error is determined based on a comparison between the physical count data and inventory record data for each of the part numbers counted. The method further includes adjusting the inventory record data based on the inventory error.

### TECHNICAL FIELD

The present disclosure relates generally to inventory management systems and, more particularly, to statistical methods for stock record verification for small inventory populations in inventory management environments.

### BACKGROUND

In many business environments, inventory management may be imperative to the successful operation of the business. For example, inventory management processes may be particularly critical for part suppliers that rely on maintaining minimum inventory stock levels sufficient to meet customer demand, without overstocking the inventory. In these types of business environments, it is important that the inventory stock record for each part number is accurate, as errors in the inventory record may lead to the costly overstocking or under-stocking of parts, which may increase inventory maintenance and storage costs and adversely affect the ability to maintain a service level to the customer, respectively.

Early inventory record verification processes relied heavily on periodic (e.g., annual, semi-annual, monthly) cycle count programs or “wall-to-wall” physical counts of all of the parts in inventory. However, physical inventory counts of entire inventory populations are often inefficient, costly, and significantly disruptive to warehouse operations and often introduce error by as much as 20% to 40% based on value. Periodic cycle count programs are often expensive and can introduce error to the warehouse also. In addition, periodic cycle count programs do not provide an inventory accuracy position until the full cycle of the periodic program has been completed. Consequently, statistical count processes were developed that required physical counts of only a relatively small sample of part numbers selected from each of a plurality of groups (or strata) associated with the larger inventory population. By subdividing the inventory population into groups according to one or more features common to members of the group, the physical count data associated with the smaller sample size can be reliably extrapolated across the larger group, potentially limiting the cost, size, and disruption associated with large physical counts.

One such statistical count process is described in U.S. Patent Application No. 2006/0064365 (“the '365 publication”) to Yancey. The '365 publication describes a system and method for auditing records associated with very large sample populations (i.e., populations with greater than 5,000 samples). The method of the '365 publication includes establishing a high value threshold level that requires a full physical count of each item with a value that exceeds the high threshold value. The method also includes establishing a low value threshold level that requires no physical counting of records below the low threshold value. Additional thresholds may be established between the high and low threshold levels, the values and boundaries of which may be determined based on the high and low thresholds and the number of desired thresholds between the low and high thresholds.

Although the process described in the '365 publication may be useful for extremely large inventory populations, it may be inaccurate for small inventory populations. For example, the system of the '365 publication does not statistically sample or even examine part numbers associated with the lowest value strata. While this may be appropriate in inventories that contain enough part numbers and strata to maintain an appropriate confidence factor for the overall inventory population, this may lead to significant error in small inventory environments, where neglecting statistical count data associated with an entire stratum (even the lowest value stratum) may lead to an unacceptable decrease in confidence in the inventory record, potentially invalidating the count results.

Most large inventories contain a sufficient quantity of part numbers in each stratum to select a sample size large enough to obtain a desired confidence factor. In small inventory populations, however, conventional stratification processes may create some groups that do not contain an adequate number of parts to allow for selection of a statistically valid sample size. Thus, in order to accurately verify stock records for inventory warehouse environments without physically counting each product in inventory, a statistical test count process for small inventory populations may be required.

The presently disclosed method for stock record verification for small inventory populations is directed toward overcoming one or more of the problems set forth above.

### SUMMARY OF THE INVENTION

In accordance with one aspect, the present disclosure is directed toward a method for stock record verification for small inventory populations. The method may comprise establishing a first group that includes a plurality of part numbers having values above a predetermined threshold, and establishing a second group that includes a plurality of part numbers having values below the predetermined threshold. A plurality of part numbers may be randomly selected from among the plurality of part numbers in the second group. The method may also include receiving physical count data associated with each of the part numbers in the first group and the randomly selected part numbers from the second group. An inventory error may be determined based on a comparison between the physical count data and inventory record data for each of the part numbers counted. The method may further include adjusting the inventory record data based on the inventory error.

According to another aspect, the present disclosure is directed toward a method for stock record verification for small inventory populations. The method comprises establishing a first group that includes a plurality of part numbers having values above a predetermined threshold, and establishing a second group that includes a plurality of part numbers having values below the predetermined threshold. The method may also include selecting, by a random sample generator, a plurality of part numbers from among the part numbers in the second group. Physical count data associated with each of the part numbers in the first group and the selected part numbers from the second group may be received, and an inventory error may be determined based on a comparison between the physical count data and inventory record data for each of the part numbers counted. The inventory record data may be adjusted based on the inventory error. The predetermined threshold may be established such that the total value of part numbers associated with the first group is less than 40% of the total value of part numbers in the inventory population.

In accordance with yet another aspect, the present disclosure is directed toward a computer readable medium for use on a computer system, the computer readable medium having computer executable instructions for performing a method comprising establishing a first group that includes a plurality of part numbers having values above a predetermined threshold, and establishing a second group that includes a plurality of part numbers having values below the predetermined threshold. The method may also include randomly selecting a plurality of part numbers from among the part numbers in the second group. Physical count data associated with each of the part numbers in the first group and the randomly selected part numbers from the second group may be received, and an inventory error may be determined based on a comparison between the physical count data and inventory record data for each of the part numbers counted. The inventory record data may be adjusted based on the inventory error.

### BRIEF DESCRIPTION OF THE DRAWINGS

FIG. 1 illustrates an exemplary disclosed inventory environment consistent with certain disclosed embodiments;

FIGS. 2A and 2B provides an exemplary disclosed stratification process for establishing a plurality of groups for a hybrid test count process consistent with the disclosed embodiments;

FIG. 3 provides a flowchart depicting an exemplary stock record verification method for small inventory populations; and

FIG. 4 provides a flowchart depicting another exemplary stock record verification process for small inventory populations, consistent with the disclosed embodiments.

### DETAILED DESCRIPTION

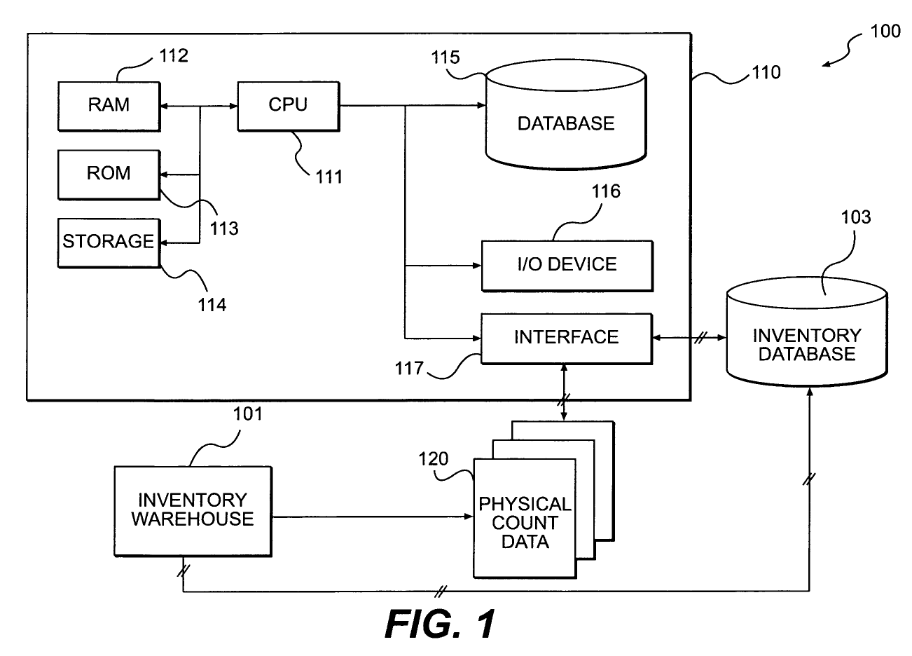

FIG. 1 provides a block diagram illustrating an exemplary disclosed inventory environment 100. Inventory environment 100 may include any type of environment associated with monitoring and/or managing an inventory that includes a population of elements. For example, inventory environment 100 may include a product warehouse configured to receive and distribute large numbers of products for operating a business. Inventory environment 100 may include, among other things, an inventory warehouse 101 containing a plurality of products, an inventory database 103, and a system 110 for maintaining inventory records.

Inventory warehouse 101 may include any type of facility for storing a plurality of products. Products, as the term is used herein, may include any physical or virtual element that may be used as a product associated with a business. Non-limiting examples of physical products may include machines or machine parts or accessories such as, for example, electronic hardware or software, work implements, traction devices such as tires, tracks, etc., transmissions, engine parts or accessories, fuel, or any other suitable type of physical product. Non-limiting examples of virtual products may include inventory data, product documentation, software structures, software programs, financial data or documents such as stock records, or any other type of virtual product. Inventory warehouse 101 may include, for example, a parts depot, a product showroom, a document storage facility, or any other type of facility suitable for storing physical and/or virtual products.

Inventory database 103 may include any type of electronic data storage device that may store data information. Inventory database 103 may contain one or more inventory records associated with each of the plurality of products associated with inventory warehouse 101. Inventory database 103 may constitute a standalone computer system that includes one or more computer programs for monitoring and/or maintaining inventory records associated therewith. Alternatively and/or additionally, inventory database 103 may be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may typically deal with an inventory warehouse.

System 110 may include any type of processor-based system on which processes and methods consistent with the disclosed embodiments may be implemented. For example, as illustrated in FIG. 1, system 110 may include one or more hardware and/or software components configured to execute software programs, such as software for managing inventory environment 100, inventory monitoring software, or inventory transaction software. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

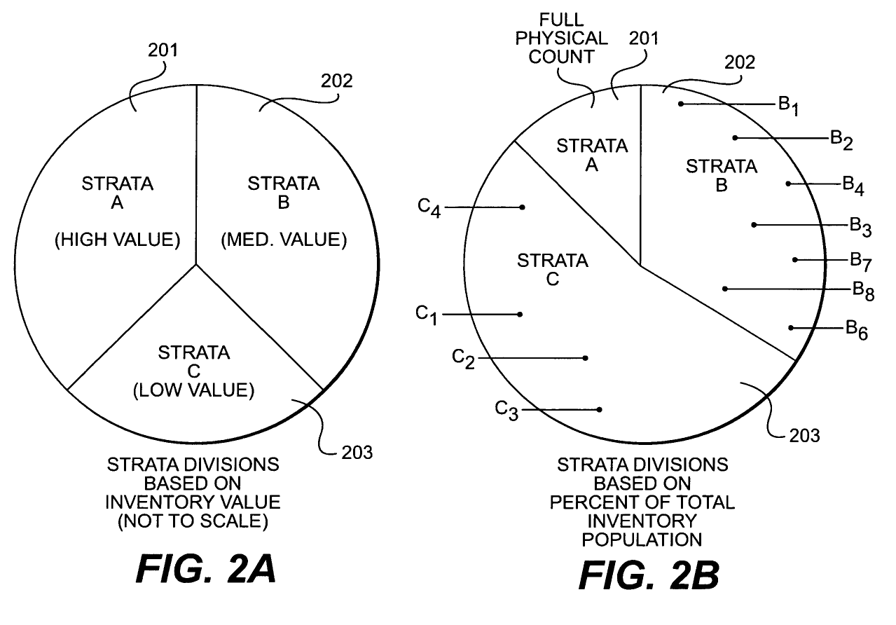

CPU 111 may include one or more processors, each configured to execute instructions and process data to perform one or more functions associated with system 110. As illustrated in FIG. 2, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM 112 for execution by CPU 111.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and/or CPU 111. For example, database 115 may include, among other things, inventory record data and historical inventory data, such as past adjustments to inventory records based on physical count data 120 and/or previous inventory records. Inventory record data includes accounting data indicative of the quantity of each part number that should be located in inventory warehouse. In contrast with actual inventory data, inventory record data may be based on official inventory transactions, such as sales, replenishments, etc. Thus, lost, misplaced, or stolen inventory items may not be reflected in the inventory record data. CPU 111 may access the information stored in database 115 for comparing the physical count data 120 with the inventory record data to determine whether an adjustment to the inventory record may be required. CPU 111 may also analyze current and previous inventory count records to identify trends in inventory count adjustments. These trends may then be recorded and analyzed to adjust one or more aspects associated with an inventory control process, which may potentially reduce inventory management errors leading to product loss and/or inventory write-off. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110. I/O devices 116 may also include a display including a graphical user interface (GUI) for outputting information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network.

System 110 may be configured to perform certain tasks associated with a statistical test count process, to identify inventory errors associated with an inventory control process. These inventory errors may assist inventory management personnel in diagnosing a source of error in the inventory management process and modifying the process to substantially reduce or eliminate the error.

System 110 may be configured to divide (using a software stratification process) an inventory population into a plurality of subpopulations or groups, called strata, based on one or more predetermined criteria. Using this stratification method, a statistically robust sample may be selected such that analysis based on the sample may be accurately and confidently extrapolated over the respective subpopulation and/or the entire inventory population. The predetermined criteria may include any suitable characteristic or feature that may serve as a basis for subdividing a large product population into one or more groups. For example, according to one embodiment, the predetermined criteria may include part value. Accordingly, system 110 may subdivide the larger inventory population into one or more strata based on the value of the parts, with high-value parts being grouped together in a first stratum, medium-value parts being grouped together in a second stratum, and low-value parts being grouped together in a third stratum. It is contemplated that additional and/or different criteria may be used to subdivide the larger inventory population. For example, the inventory population may be grouped according to warehouse location, product size, product type, or any other suitable criteria.

System 110 may be configured to randomly select one or more part numbers for physical counting from among a plurality of part numbers associated with one or more of the strata. For example, CPU 111 may be configured to execute sample generation software that randomly selects a plurality of part numbers from among a list of part numbers associated with each stratum. Alternatively and/or additionally, system 110 may include a separate random sample generator (not shown) configured to randomly select the part numbers from each stratum.

FIGS. 2A and 2B illustrate an exemplary disclosed stratification process performed by system 110, in accordance with an exemplary disclosed embodiment. As illustrated in FIG. 2A, system 110 may be configured to subdivide an inventory population into a plurality of strata, the number of strata depending upon the size of the inventory population, the predetermined stratification criteria, and/or the number of parts required in each stratum to facilitate selection of a statistically valid sample size. According to one embodiment, the inventory population may be stratified based on value, with high-value part numbers being placed in a first strata 201 (Strata “A”), medium-value parts being placed in a second strata 202 (Strata “B”), and low-value parts being placed in a third strata 203 (Strata “C”).

FIG. 2A provides a pie chart depicting strata divisions based on inventory value, illustrating the relative percentage of the value of each stratum with respect to the overall value of the inventory population. As illustrated in FIG. 2A, first stratum 201 (corresponding to the high-value parts) may be selected such that sum of the value of the parts in first stratum 201 is approximately 30-40% of the total value of the inventory population. Second stratum 202 (corresponding to the medium-value parts) may be selected such that the sum of the value of the parts in second stratum 202 constitutes approximately 25-40% of the total inventory value. Third stratum 203 (corresponding to the low-value parts) may be selected such that the sum of the value of the parts in third stratum 203 is approximately 15-30% of the total inventory value. The percent ranges associated with each stratum listed above are exemplary only, and may be modified depending upon the desired number of parts in each stratum. For example, if the predetermined criteria are defined such that first stratum 201 contains only a small number of part numbers, an inventory manager may adjust the predetermined criteria to include additional part numbers in first stratum 201, if, for example, such an increase will not place a significant burden on the statistical test count process.

FIG. 2B provides a pie chart illustrating the relative percentage of the total inventory value corresponding to each stratum of FIG. 2A. As illustrated in FIG. 2B, first stratum 201, while comprising part numbers that constitute a substantial percentage of the overall inventory value, may constitute a relatively small percentage of the part numbers of the inventory. For instance, in an automobile parts warehouse, engine systems and transmissions may comprise 30-40% of the total value of the inventory stock. However, the quantity of engine systems and transmissions stocked in inventory may comprise only a small percentage of the total inventory stock, as the demand for such expensive items may be substantially less than the demand for less expensive inventory items.

In contrast, third stratum 203, while containing part numbers that constitute a relatively small percentage of the total inventory value, may comprise a majority of the parts in inventory. Following the example above, inexpensive parts, such as, for example, brake pads, windshield wipers, electrical fuses, oil filters, etc., while constituting only 15-30% of the total inventory value, may comprise 60-70% of the total parts in inventory.

Small inventory populations (i.e., inventory populations containing less than 1000 total part numbers) may create some unique challenges for statistical test count processes. As explained, small inventory populations may include a substantially larger quantity of low-value part numbers than high-value part numbers. Moreover, as illustrated in FIGS. 2A and 2B, high-value part numbers in small inventory populations may contain a relatively small number of parts, which may not be conducive to the selection of statistically valid sample sizes. Accordingly, test count processes that rely solely on random selection of a small percentage of parts in each strata may be inaccurate for groups containing a relatively small population of high-valued parts.

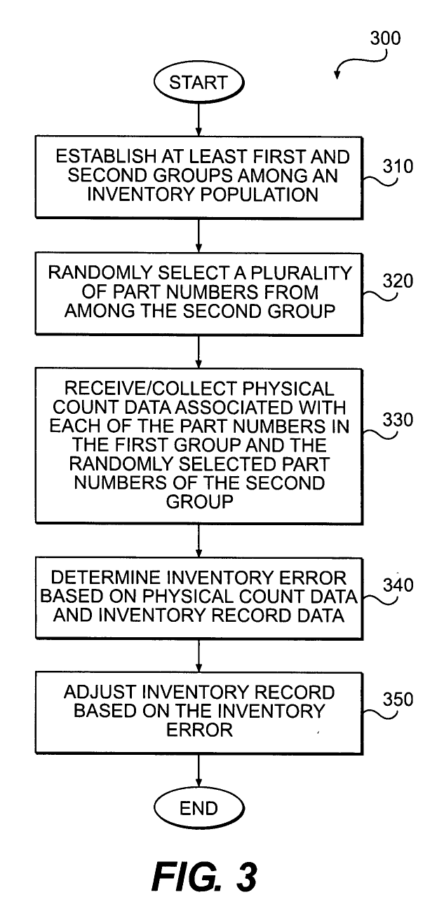

Processes and methods consistent with the disclosed embodiments provide a statistical test count process that combines certain aspects of full physical inventory counts and statistical test count processes to accurately and confidently verify inventory records, without requiring complete full physical inventory counts for an entire inventory population. As a result, system 110 may provide inventory management environments with a method for confidently and accurately performing statistical test count processes for small inventory populations by employing a hybrid method that performs full physical counts for high value part numbers, while reserving statistical test count processes for low- and medium-value strata. FIG. 3 provides a flowchart 300 illustrating an exemplary test count process consistent with the disclosed embodiments.

As illustrated in FIG. 3, system 110 may stratify an inventory population to establish first and second groups (or strata) from among the plurality of parts associated with the inventory population (Step 310). According to one embodiment, system 110 may establish a first group that includes a plurality of part numbers having values above a predetermined value. As explained, the predetermined value may be selected or optimized such that the total value of the part numbers contained in the first group is approximately 30-40% of the total value of the part numbers in inventory. Similarly, system 110 may establish a second group that includes a plurality of part numbers having values less than the predetermined value. It is contemplated that the second groups may be further divided or stratified into a plurality of groups.

Once the inventory has been divided into a plurality of groups, system 110 may randomly select a plurality of part numbers from among the second group (Step 320) and flag each of the randomly selected part numbers for physical count. As explained, CPU 111 may execute random sample selection software that randomly selects a plurality of part numbers from among the total list of part numbers associated with the second group. According to one embodiment, the number of parts (e.g., sample size) selected from the second group may be based on the total value of the inventory population associated with the second group. Specifically, according to one embodiment, the number of parts may be determined as:

$$η = \frac{V \cdot CF}{P} \qquad ( Eq . 1 )$$

where η is sample size, V is total value of inventory population associated with the second group, CF is the desired confidence factor in the inventory record data, and P is the desired precision associated with the inventory record data. Alternatively and/or additionally, the sample size may be based on the total number of parts in the second group using the formula:

$$η = \frac{I \cdot CF}{P} \qquad ( Eq . 2 )$$

where η is sample size, I is the total quantity of part numbers associated with the second group, CF is the desired confidence factor in the inventory record data, and P is the desired precision associated with the inventory record data.

System 110 may randomly select one or more part numbers from among the second group of part numbers in accordance with the sample size. Each of the randomly selected part numbers and at least a substantial majority of the part numbers in the first group may be flagged for physical counting during an inventory count process.

Once physical counts have been performed for the first group of parts and the selected part numbers from the second group of parts, system 110 may receive/collect the physical count data (Step 330). System 110 may receive this data in response to an inventory warehouse personnel's input upon completion of a physical count of one or more of the parts numbers. Alternatively and/or additionally, system 110 may automatically collect physical count data if, for example, inventory management personnel count the part numbers using electronic scan technology (e.g., RFID, wireless handheld scanners, barcode readers, etc.), which may be networked or electronically integrated with system 110.

System 110 may determine an inventory error for each part number that was physically counted, based on the received physical count data and the inventory record data (Step 340). For example, system 110 may be configured to compare physical count data with inventory record data and determine the inventory error based on the difference between the physical count data and the inventory record data. System 110 may adjust the inventory record based on the determined inventory error (Step 350). For example, system 110 may adjust the inventory record for the part numbers counted as part of the test count process. Alternatively and/or additionally, system 110 may determine the average inventory error for each strata and compare the inventory error with an inventory error threshold. If the average inventory error for one or more of the strata exceeds an inventory error threshold, which may be indicative of a potential problem associated with the inventory, system 110 may perform additional statistical counts using larger sample sizes to identify the potential source of inventory error. Alternatively and/or additionally, system 110 may perform inventory test counts with more frequency in an attempt to isolate and identify any potential problems as soon as possible.

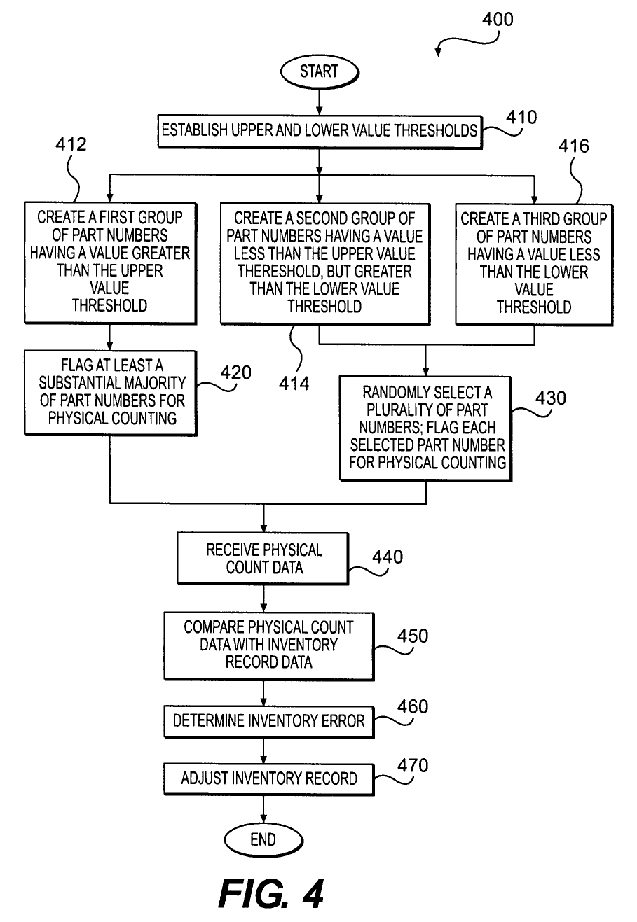

As explained, because a large majority of the part numbers (e.g., 80-90%) may comprise the lower 50-60% of the total inventory value, it may be advantageous to stratify the inventory population into more than two groups by subdividing the lower-value parts (e.g., the lower 50-60% of the inventory) into multiple groups (e.g., medium- and low-value parts). FIG. 4 provides a flowchart 400 illustrating a stratification method that divides an inventory population into three value groups (e.g., high-, medium-, and low-value parts). By physically counting a substantial majority of the parts in the high-value group and statistically counting the medium and low-value part numbers by selecting sample sizes appropriate to achieve a desired confidence factor in the overall inventory value, system 110 may provide an accurate and reliable method for counting small inventory populations, without requiring full “wall-to-wall” physical counts for the entire population.

As illustrated in FIG. 4, upper and lower value thresholds may be established as the stratification criteria for the statistical test count process (Step 410). For example, system 110 may poll the inventory record and establish an upper value threshold (e.g., $1,000, $1,500, etc.) such that the total value of part numbers whose value exceeds the upper value threshold comprise 30-40% of the total inventory value. Similarly, system 110 may poll the inventory record and establish a lower value threshold (e.g., $25, $50, etc.) such that the total value of part numbers whose value is less than the lower value threshold comprise 15-30% of the total inventory value.

System 110 may be configured to adjust the ranges for the upper and lower thresholds such that the number of parts in each of the corresponding medium- and low-value groups is appropriate to support the statistical test count process. For example, if the number of parts in the medium-value range is too low to support a statistically valid sample selection, the lower threshold can be lowered (e.g., from $50 to $25), thereby increasing the number of parts in the medium-value threshold. Those skilled in the art will recognize that, because the low-value group comprises a relatively small percentage of the total value of the inventory, errors in the statistical test count data for the low-value group may have a relatively minor affect on the accuracy of the statistical test count data. For instance, for an inventory population valued at $1,000,000 with corresponding low-value strata valued at 15%, or $150,000, even a relatively large statistical test count error of 20% ($30,000) for the low-value strata results in an overall error of 3% of the total inventory value. Accordingly, in order to limit inventory error and maintain confidence in the overall inventory, the upper and lower thresholds may be adjusted such that the high- and medium-value groups contain a large majority of the total inventory value, while containing a quantity of parts appropriate to support efficient and accurate statistical test count processes.

Once the upper and lower thresholds have been established, system 110 may create a first group of part numbers having a value greater than the upper value threshold (Step 412). For example, system 110 may compare each part number in the inventory population with the upper value threshold and associate the part number with a first group if the value of the part number exceeds the upper value threshold. For example, if the upper threshold value is established at $1,000, all part numbers with values that exceed $1,000 will be associated with the first group.

Similarly, system 110 may create second and third groups of part numbers (Steps 414, 416). The second group of part numbers may include any parts numbers with values less than the upper threshold but greater than a lower threshold. The third group of part numbers may include parts with values less than both upper and lower threshold values. According to one embodiment, the number of parts associated with the first group of part numbers may be less than the number of part associated with the second group of part numbers, which may be less than the number of parts associated with the third group of part numbers. According to another embodiment, the sum of part numbers associated with the first and second groups of part numbers may be less than the quantity of part numbers associated with the third group of part numbers.

Upon creation of the groups of part numbers, the part numbers for physical inventory counts may be selected. For the first group, system 110 may identify or “flag” at least a substantial majority of the part numbers for physical counting (Step 420). As explained, the first group of part numbers may comprise 30-40% of the total inventory value, while accounting for a relatively small percentage of parts. Accordingly, a full physical count may be performed to ensure accuracy and confidence in the resulting count data. Moreover, because the first group of parts includes a relatively small number of parts, the cost and disruption due to a full physical count of the part number in the first group may be limited.

Because the second and third groups of part numbers may include considerably more part numbers than the first group, system 110 may initiate a statistical test count process for these groups. The statistical test count process may comprise randomly selecting part numbers from each of the second and third groups of part numbers and flagging each randomly selected part number for physical counting (Step 430). For example, as explained, system 110 may include random sample generation software. The random sample generation software may determine the sample size, based on the number of parts in each of the second and third groups, the desired confidence factor associated with the resulting physical count data, and the total value of each of the second and third groups. The software may randomly select part numbers from each of second and third groups in accordance with the sample size. System 110 may flag each of the randomly selected part numbers for physical counting by inventory personnel. For example, for each part number flagged, system 110 may provide a physical count request to one or more inventory management personnel, identifying the flagged part and requesting that a physical count be performed for the part.

Once physical counts have been performed for each part number flagged for physical counting, system 110 may receive the physical count data (Step 440) and compare the physical count data with inventory record data (Step 450). For example, system 110 may execute software configured to analyze the received physical count data with respect the inventory record data for each part number counted. The software may determine, based on the analysis, an inventory error associated with each part number (Step 460). The inventory error may include a percent error that the inventory record differs from the physical count data. For example, if the physical count data reveals that 87 pieces of part number “A” were located in inventory and the inventory record data indicates that 90 pieces of part number “A” should be located in inventory, the resulting inventory error may be calculated as 3.4% (i.e., the percent error between the inventory record data and the physical count data).

Once the inventory error for each part number counted during the physical count process has been determined, system 110 may adjust the inventory record to correct for the inventory error (Step 470). For each part number physically counted, the inventory record may be adjusted by the physical count data. Alternatively and/or additionally, system 110 may compare the inventory error with an inventory error threshold. If the inventory error exceeds an the inventory error threshold, which may be indicative of a potential problem associated with the inventory, system 110 may perform additional statistical counts using larger sample sizes or with more frequency to identify the potential source of inventory error. Thus, if the inventory error or a standard deviation of error is abnormally high (e.g., exceeding a predetermined standard) the sample size for the test count may be increased to determine if the error was a function of the randomly selected sample. According to one embodiment, system 110 may schedule a physical count for the entire population if an elevated inventory error condition persists.

According to one embodiment, system 110 may be configured to generate a report summarizing the inventory verification process. For example, system 110 may create an inventory audit report that includes a variety of data including, for example, data summarizing the stratification criteria selected, the part numbers that were physically counted during the test count process, the inventory error for each part number counted, the average inventory error for each strata, the overall confidence factor and precision of the resulting statistical test count process, and any data that may assist an inventory manager in determining the effectiveness of the supply chain process.

Although certain aspects of the exemplary method may be illustrated and/or described in connection with or being performed by system 110, it is contemplated that the method (or one or more aspects associated therewith) may be implemented or performed manually, without the use of inventory management system 110.

### INDUSTRIAL APPLICABILITY

Although the presently disclosed methods are described in connection with inventory record audits for parts in an inventory warehouse environment, they may be applicable to any environment that requires reconciling of record data with actual data. Specifically, the presently disclosed methods provide a hybrid statistical test count process for small inventory populations in which a plurality of products are stratified into smaller groups based on product value. The size of the groups may be selected to support an efficient full physical count process for the high-value stratum and statistical test count processes for lower-value part numbers. As a result, the presently disclosed methods provide accurate test count processes for small product populations, without requiring “wall-to-wall” physical counts for each product in the population.

The presently disclosed methods for stock record verification for small inventory population may have several advantages. First, the inventory record verification process described herein may be more accurate than conventional verification processes developed for large inventory populations. For example, because the stratification process requires the creation of substantially fewer groups than conventional inventory stratification processes, smaller populations may be more easily divided into groups that contain a sufficient quantity of parts from which a statistically valid sample size may be extracted. As a result, the presently disclosed methods may provide accurate and reliable inventory error calculations for small inventory populations, as groups selected to undergo statistical test count processes contain large enough product populations to select statistically valid sample sizes, while still providing an appropriate correlation between the members of the group to confidently extrapolate characteristic data across the group's population.

In addition, the presently disclosed methods may have significant cost advantages. For example, because the process described herein provides a method for accurately and reliably counting small populations, it may be no longer necessary to perform “wall-to-wall” physical counts to audit and verify stock records for these small populations. Accordingly, costs and disruptions associated with “wall-to-wall” physical counts may be reduced or eliminated.

It will be apparent to those skilled in the art that various modifications and variations can be made to the presently disclosed method for stock record verification for small inventory populations. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for stock record verification for small inventory populations, comprising:
establishing a first group that includes a plurality of part numbers having values above a predetermined threshold;
establishing a second group that includes a plurality of part numbers having values below the predetermined threshold;
randomly selecting a plurality of part numbers from among the plurality of part numbers in the second group;
receiving physical count data associated with each of the part numbers in the first group and the randomly selected part numbers from the second group;
determining an inventory error based on a comparison between the physical count data and inventory record data for each of the part numbers counted; and
adjusting the inventory record data for each of the part numbers counted based on the inventory error.

2. The method of claim 1, wherein determining the inventory error includes:
comparing the physical count data for each part number that is physically counted with inventory record data associated with the respective part number; and
determining a percent error based on the comparison.

3. The method of claim 1, wherein adjusting the inventory record data includes adjusting the inventory record for each part number that is physically counted based on the inventory error associated the respective part number.

4. The method of claim 1, wherein adjusting the inventory record further includes:
determining an average inventory error for the second group based on the physical count data associated with the second group;
comparing the average inventory error with an inventory error threshold; and
performing an additional count for groups with average inventory errors that exceed an inventory error threshold.

5. The method of claim 1, wherein selecting a plurality of part numbers from among the second group of part numbers includes:
determining a sample size based on one or more of a total number of part numbers associated with the second group, a total value of the second group, a desired confidence factor in the inventory record data, and a desired precision associated with the inventory record data; and
randomly selecting a plurality of part numbers from among the second group, based on the determined sample size.

6. The method of claim 5, wherein the sample size is determined by:
$$η = \frac{V \cdot CF}{P}$$
where η is sample size, V is total value of inventory population associated with the second group, CF is the desired confidence factor in the inventory record data, and P is the desired precision associated with the inventory record data.

7. The method of claim 5, wherein the sample size is determined by:
$$η = \frac{I \cdot CF}{P}$$
where η is sample size, I is the total quantity of part numbers associated with the second group, CF is the desired confidence factor in the inventory record data, and P is the desired precision associated with the inventory record data.

8. The method of claim 1, wherein the second group may be subdivided into one or more subgroups, each subgroup associated with a different value range below the predetermined threshold.

9. The method of claim 1, wherein the predetermined threshold is established such that a total value of part numbers associated with the first group is approximately 25%-40% of a total value of the inventory population.

10. The method of claim 1, further including generating an inventory adjustment summary including one or more of the physical count data for each part number counted, inventory error for each part number counted, and data indicative of adjustments made to the inventory record.

11. A method for stock record verification for small inventory populations, comprising:
establishing a first group that includes a plurality of part numbers having values above a predetermined threshold;
establishing a second group that includes a plurality of part numbers having values below the predetermined threshold;
selecting, by a random sample generator, a plurality of part numbers from among the plurality of part numbers in the second group;
receiving physical count data associated with each of the part numbers in the first group and the selected part numbers from the second group;
determining an inventory error based on a comparison between the physical count data and inventory record data for each of the part numbers counted; and
adjusting the inventory record data for each of the part numbers counted based on the inventory error;
wherein the predetermined threshold is established such that a total value of part numbers associated with the first group is less than 40% of a total value of part numbers in the inventory population.

12. The method of claim 11, wherein determining the inventory error includes:
comparing the physical count data for each part number that is physically counted with inventory record data associated with the respective part number; and
determining a percent error based on the comparison.

13. The method of claim 11, wherein adjusting the inventory record data includes adjusting the inventory record for each part number that is physically counted based on the inventory error associated the respective part number.

14. The method of claim 11, wherein adjusting the inventory record further includes:
determining an average inventory error for the second group based on the physical count data associated with the second group;
comparing the average inventory error with an inventory error threshold; and
performing an additional count for groups with average inventory errors that exceed an inventory error threshold.

15. The method of claim 11, wherein selecting a plurality of part numbers from among the second group of part numbers includes:
determining a sample size based on one or more of a total number of part numbers associated with the second group, a total value of the second group, a desired confidence factor in the inventory record data, and a desired precision associated with the inventory record data; and
randomly selecting a plurality of part numbers from among the second group, based on the determined sample size.

16. The method of claim 11, wherein the second group may be subdivided into one or more subgroups, each subgroup associated with a different value range below the predetermined threshold.

17. The method of claim 11, wherein the predetermined threshold is established such that the total value of part numbers associated with the first group is approximately 25% to 40% of the total value of the inventory population.

18. A computer readable medium for use on a computer system, the computer readable medium having computer executable instructions for performing a method comprising:
establishing a first group that includes a plurality of part numbers having values above a predetermined threshold;
establishing a second group that includes a plurality of part numbers having values below the predetermined threshold;
randomly selecting a plurality of part numbers from among the plurality of part numbers in the second group;
receiving physical count data associated with each of the part numbers in the first group and the randomly selected part numbers from the second group;
determining an inventory error based on a comparison between the physical count data and inventory record data for each of the part numbers counted; and
adjusting the inventory record data for each of the part numbers counted based on the inventory error.

19. The computer-readable medium of claim 18, wherein determining the inventory error includes:
comparing the physical count data for each part number that is physically counted with inventory record data associated with the respective part number; and
determining a percent error based on the comparison.

20. The computer-readable medium of claim 18, wherein adjusting the inventory record data includes
adjusting the inventory record for each part number that is physically counted by at least the inventory error associated the respective part number;
determining an average inventory error for the second group based on the physical count data associated with the second group;
comparing the average inventory error with an inventory error threshold; and
performing an additional count for groups with average inventory errors that exceed an inventory error threshold.
